(19) United States
(12) Patent Application Publication
(10) Pub. No.: US 2017/0316610 A1
(43) Pub. Date: Nov. 2, 2017

(54) ASSEMBLY INSTRUCTION SYSTEM AND ASSEMBLY INSTRUCTION METHOD

(71) Applicant: NATIONAL CHIAO TUNG UNIVERSITY, Hsinchu City (TW)

(72) Inventors: I-Chen LIN, Hsinchu City (TW); Li-Chen WU, New Taipei City (TW); Ming-Han TSAI, Taipei City (TW); Jen-Hui CHUANG, Hsinchu City (TW)

(21) Appl. No.: 15/206,325

(22) Filed: Jul. 11, 2016

(30) Foreign Application Priority Data
Apr. 28, 2016 (TW) 105113288

(51) Int. Cl. G06T 19/00; G02B 27/01

(52) U.S. Cl. CPC G06T 19/006; G02B 27/017; G02B 2027/0178

(57) ABSTRACT

Assembly instruction system includes at least one depth camera, database, processor, and display. Depth camera captures first object image. Database stores multiple known object images and assembly tree. Processor compares first object image with known object images separately to recognize first object corresponding to first object image and a three-dimensional position and orientation of first object, and obtains second object (or some other multiple objects) corresponding to first object according to captured image and assembly tree. Processor generates at least one virtual arrow according to three-dimensional position and orientation. Display displays augmented reality image having at least one virtual arrow added on first object image and second object (or some other multiple objects) image(s). Virtual arrow indicates a moving direction for assembling first object and second object (or some other multiple objects). The above process is repeatedly performed until the whole device is assembled.

### RELATED APPLICATIONS

This application claims priority to Taiwan Application Serial Number 105113288, filed Apr. 28, 2016, which is herein incorporated by reference.

### BACKGROUND

### Field of Invention

The present disclosure relates to an assembly instruction system and an assembly instruction method. More particularly, the present disclosure relates to an augmented reality assembly instruction system and assembly instruction method.

### Description of Related Art

The now existing method for instructing a user to assemble objects is mainly by reading text or looking at figures in a print version. The user thus needs to put together physical objects in three dimensions according to a two-dimensional instruction. Under the circumstances, it is necessary for the user to image the relationships between the two-dimensional figures and the three-dimensional physical objects. In addition, the user can not know whether the user's current action and whether the object being currently picked up are correct or not when assembling. Hence, there is a lack of interactions between the user and the assembly method when how to put together the physical objects is instructed by the traditional method in which text or figures in a print version is utilized.

In recent years, studies regarding how to introduce the augmented reality (AR) technology have been initiated to add instruction text or figures on a real image so as to guide the user to assemble physical objects in a real-time manner. In order to estimate the three-dimensional position and disposition direction of the object to be assembled, most of the current systems need to attach an obvious pattern or mark to the object. However, most objects are not suitable for being attached with a special mark or embedded with a sensor.

For the foregoing reasons, there is a need to solve the above-mentioned problems by providing a convenient system and method for assembling physical objects, which is also an objective that the industry is eager to achieve.

### SUMMARY

An assembly instruction system is provided. The assembly instruction system comprises at least one depth camera, a database, a processor, and a display. The depth camera is configured to capture a first objet image. The database is configured to store a plurality of known object images and an assembly tree. The processor is configured to compare the first object image with the known object images separately to recognize a first object corresponding to the first object image and a three-dimensional position and a three-dimensional orientation of the first object, and obtain a second object corresponding to the first object according to the assembly tree. The processor generates at least one virtual arrow according to the three-dimensional position and the three-dimensional orientation when the at least one depth camera simultaneously captures the first object image and a second object image of the second object. The display is configured to display an augmented reality image having the at least one virtual arrow added on the first object image or the second object image. The virtual arrow is used for indicating a moving direction for assembling the first object and the second object.

The disclosure provides an assembly instruction method. The assembly instruction method comprises the following steps: capturing a first objet image; storing a plurality of known object images and an assembly tree; comparing the first object image with the known object images separately to recognize a first object corresponding to the first object image and a three-dimensional position and a three-dimensional orientation of the first object, and obtaining a second object corresponding to the first object according to the assembly tree, generating at least one virtual arrow according to the three-dimensional position and the three-dimensional orientation when the first object image and a second object image of the second object are captured simultaneously; and displaying an augmented reality image having the at least one virtual arrow added on the first object image or the second object image. The virtual arrow is used for indicating a moving direction for assembling the first object and the second object.

It is to be understood that both the foregoing general description and the following detailed description are by examples, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

In the drawings,

FIG. 1 depicts a schematic diagram of an assembly instruction system according to one embodiment of the present disclosure;

FIG. 2 depicts a flowchart of an assembly instruction method according to one embodiment of the present disclosure;

FIG. 3 depicts a schematic diagram of establishing three-dimensional object models according to one embodiment of the present disclosure;

FIG. 4 depicts a schematic diagram of an assembly tree according to one embodiment of the present disclosure;

FIG. 5 depicts a schematic diagram of a user interface according to one embodiment of the present disclosure;

FIG. 6A to FIG. 6C depict schematic diagrams of augmented reality images in a user interface according to one embodiment of the present disclosure; and

FIG. 7 depicts a flowchart of an assembly instruction method according to one embodiment of the present disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts.

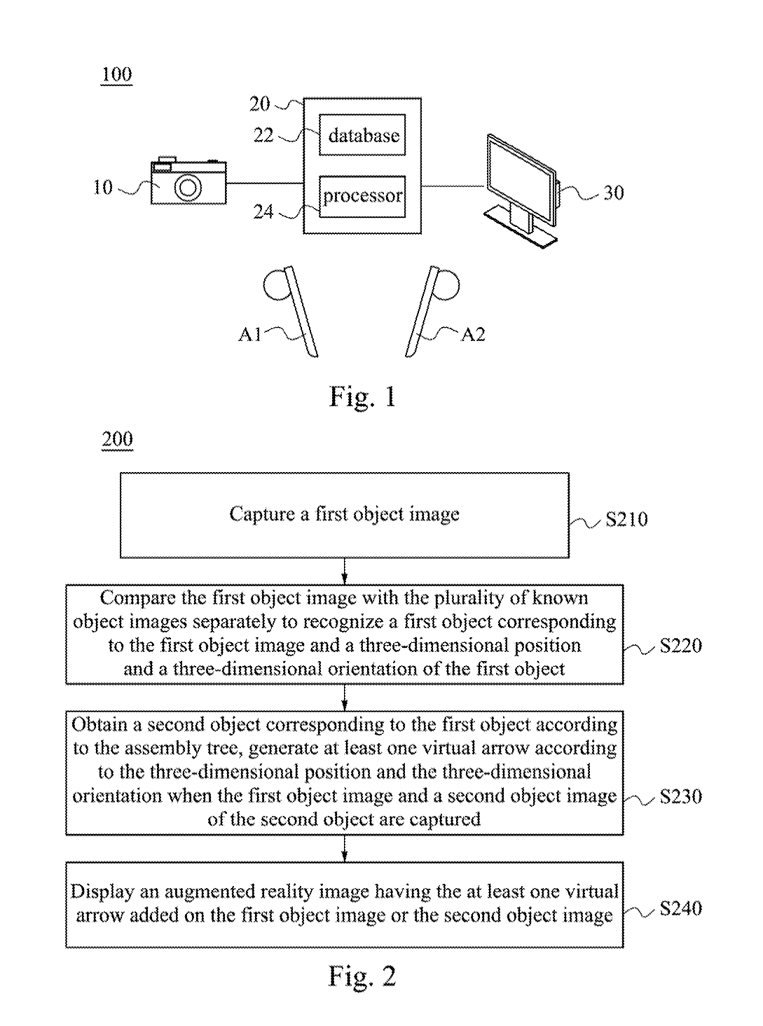

FIG. 1 depicts a schematic diagram of an assembly instruction system 100 according to one embodiment of the present disclosure. The assembly instruction system 100 comprises at least one depth camera 10, a database 22, a processor 24, and a display 30. The depth camera 10 can record depth data of an image. In one embodiment, the depth camera 10 may be realized by using an Asus Xtion camera or a Microsoft Kinect camera. Additionally, the database 22 is configured to store data. In one embodiment, the database 22, which can be implemented by using a memory, a hard disk drive, a USB memory card, etc., is configured to store a variety of data. The processor 24 is configured perform various operations, which can be implemented by using an integrated circuit, such as a micro controller, a microprocessor, a digital signal processor, an application specific integrated circuit (ASIC), or a logic circuit. In one embodiment, the database 22 and the processor 24 may be located in an electronic device 20. The electronic device 20 may be a server, a personal computer (PC), a smartphone, a tablet PC, or a laptop PC. In one embodiment, the display 30 is configured to display a computation result of the processor 24.

A description is provided with reference to FIG. 1 and FIG. 2. FIG. 2 depicts a flowchart of an assembly instruction method 200 according to one embodiment of the present disclosure. A detailed description is provided by illustrating the assembly instruction method 200 together with the assembly instruction system 100 shown in FIG. 1, but the present disclosure is not limited to the following embodiments.

In step S210, the depth camera 10 captures a first object image. In one embodiment, the depth camera 10 can capture an image of an object A1, and obtain depth data of the image. For example, in FIG. 1, the depth camera 10 can capture the image of the object A1 and an image of an object A2, and transmit the images of the objects A1, A2 to the electronic device 20, and then transmit the images of the objects A1, A2 to the display 30 through the electronic device 20, so that the display 30 displays the images of the objects A1, A2. The depth camera 10 and the electronic device 20 may be connected through a wired or wireless transmission method, for example, Bluetooth or Wifi is used for communication connection. Similarly, the electronic device 20 and the display 30 may also be communicatively connected through a wired or wireless transmission method.

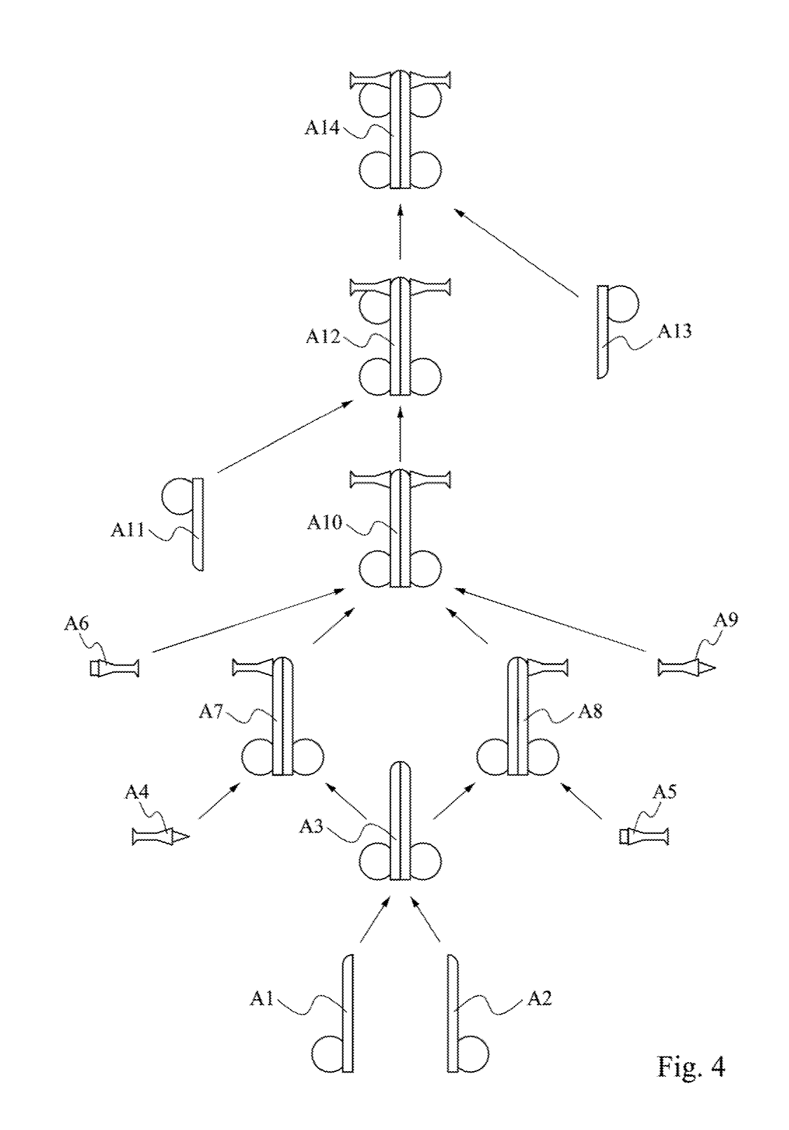

In one embodiment, the object A1 may be a part of a specific device. For example, the object A1 may be a tire or a bracket of a body of a model car. In other words, through assembling the object A1 with other multiple objects (such as those physical objects, the object A2, an object A4, an object A6 . . . , etc, in FIG. 4), a specific device (such as an object A14 in FIG. 4) can be formed.

In one embodiment, the database 22 is configured to store a plurality of known object images (such as images of the objects A1-A14 in FIG. 4) and an assembly tree. Technical features of the assembly tree are described in a detailed manner in paragraphs that illustrate FIG. 4 correspondingly. In one embodiment, after the depth camera 10 captures an object image, the processor 24 can further recognize that a current object in the object image is which of known objects in the database 22. For example, the processor 24, after comparing and obtaining that the current object is the known object A1, searches information in the assembly tree to obtain a next object (such as the object A2) that can be assembled with the current object A1. In addition, the display 30 may be configured to display the object A2 to allow a user to be informed that the object A2 should be picked up next so as to be assembled with the current object A1. A more detailed description of the present disclosure is provided as follows.

In step S220, the processor 24 compares the first object image with the plurality of known object images separately to recognize a first object corresponding to the first object image and a three-dimensional position and a three-dimensional orientation of the first object.

In one embodiment, the processor 24 compares the object image captured by the depth camera 10 with the known objects (such as the objects A1-A14 in FIG. 4) stored in the database 24 in advance to recognize the current object (such as the object A1) presented in the object image and analyze a three-dimensional position and a three-dimensional orientation of the current object A1.

In one embodiment, the processor 24 compares the object image with a color distribution (for example, the tire is black and the bracket is orange), a silhouette of a depth image (for example, a silhouette of the tire is a circle and a silhouette of the bracket of the body is a column), or a gradient of a depth image (for example, extract the current object A1 from a foreground of the whole object image) of the plurality of known object images to recognize the current object A1 comprised in the object image and obtain an identification code (ID) of the current object A1 from the database 24. The identification code may be a code representing the current object A1.

Additionally, the processor 24 recognizes the three-dimensional position and the three-dimensional orientation of the object A1 based on an extended iterative closed point method. Hence, after the processor 24 recognizes the identification code and an initial possible view angle of the object A1, the assembly instruction system 100 further uses the extended iterative closed point method to gradually fine tune the angle so as to find the most suitable angle. This method can determine the three-dimensional orientation (such as the inclination angle when being placed horizontally, vertically, or obliquely) and the three-dimensional position of the current object A1 when fulfilling the requirements of correctness and instantaneousness at the same time.

In step S230, the processor 24 obtains a second object corresponding to the first object according to the assembly tree. In one embodiment, when the depth camera 10 simultaneously captures the first object image and a second object image of the second object, the processor 24 generates at least one virtual arrow according to the three-dimensional position and the three-dimensional orientation of the first object. In another embodiment, the depth camera 10 can also generate at least one virtual arrow according to a three-dimensional position and a three-dimensional orientation of the second object. In addition, the depth camera 10 can generate at least one virtual arrow according to the three-dimensional position of the first object and the three-dimensional position of the second object in one embodiment. The virtual arrow is used for indicating a moving direction. The first object can be assembled with the second object according to the moving direction.

In one embodiment, the database 24 can store the plurality of known object images and the assembly tree in advance. In one embodiment, the assembly instruction method 200 can establish the plurality of known object images and the assembly tree in advance before going to step S210 or in an offline state, so that the plurality of known object images and the assembly tree can be used after going to step S210. A detailed description of the known object images and the assembly tree is provided as follows.

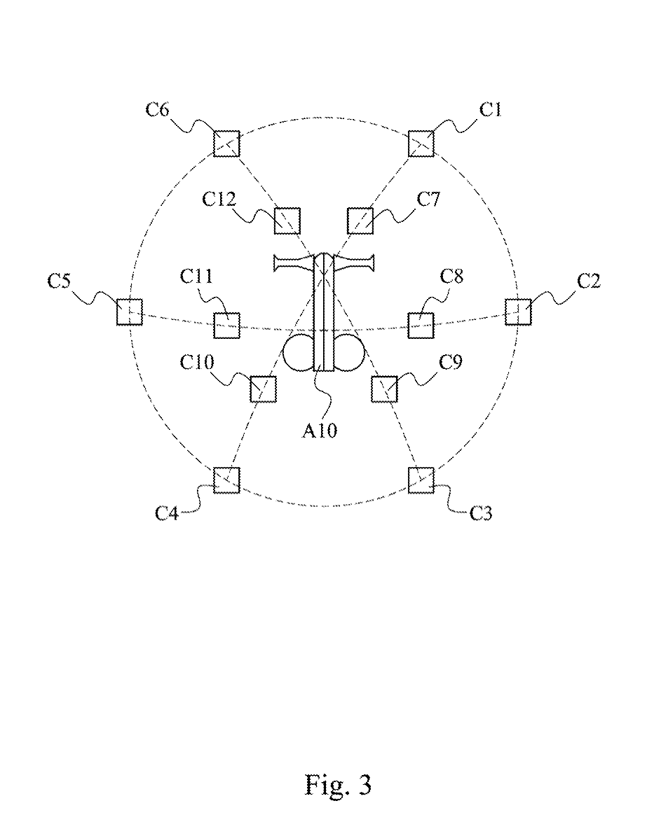

A description is provided with reference to FIG. 3 and FIG. 4. FIG. 3 depicts a schematic diagram of establishing three-dimensional object models according to one embodiment of the present disclosure. FIG. 4 depicts a schematic diagram of an assembly tree according to one embodiment of the present disclosure. In one embodiment, the assembly instruction system 100 needs to respectively establish three-dimensional object models of each object that constitutes the object A14 and objects that have been partially assembled. As shown in FIG. 4, the object A14 is a top view of a model car. The object A14 is assembled by the objects A1, A2 A4, A5, A6, A9, A11, A13. In other words, these objects are leaf nodes of the assembly tree. The objects that have been partially assembled are represented by the objects A3, A7, A8, A10, A12, A14. In other words, these objects are not the leaf nodes of the assembly tree. In this example, the assembly instruction system 100 needs to respectively establish three-dimensional object models of the objects A1-A14.

In one embodiment, as shown in FIG. 3, depth images of each of the objects (such as the object A10) at different view angles are captured from view points that are discrete and uniformly distributed in a periphery. For example, depth cameras C1-C12 capture the object A10 respectively at different view angles to obtain images of the object A10 in different facets. In one embodiment, the object A10 may be disposed at a center of a regular dodecahedron, and different projected images are captured at twenty vertexes of the regular dodecahedron. These projected images are helpful in recognizing the object and an angle thereof in the image in a real-time manner. However, this is only one example of the present disclosure, and the present disclosure is not limited in this regard. In addition, a virtual three-dimensional object model of each of the objects (such as the object A10) can be established first, and then a projection method is utilized to capture the virtual three-dimensional object model so as to more effectively obtain images of the object 14 in different facets according to one embodiment. In this manner, each of the objects A1-A14 can be respectively captured at multiple view angles. For example, the objects A1, A2, A3 . . . A14 are respectively captured at 100 different view angles to obtain 1400 object images in total, and the plurality of images thus obtained are stored in the database 22 and regarded as the known object images.

Additionally, in FIG. 4, the assembly tree is used for defining an assembly relationship between the objects and an assembly sequence of the objects. For example, the object A3 is assembled by the object A1 and the object A2, the object A7 is assembled by the object A3 and the object A4, the object A8 is assembled by the object A5 and the object A3, the object A10 is assembled by the objects A6, A7, A8, A9, and so forth. Finally, the object A14 (such as a model car) is assembled. In other words, two objects that can be assembled have a same father node. For example, a father node of the object A1 is the object A3. A father node of the object A2 is also the object A3. Therefore, the object A1 and the object A2 can be assembled as the object A3.

After the plurality of known object images and the assembly tree have been established in the database 24 in advance by using the above method, in step S230, the processor 24 then learns that the current object A1 can be assembled with the object A2 which has the same father node by reading data of the assembly tree when the processor 24 recognizes the current object (such as the object A1). In addition, as known from the assembly tree, the object A3 can be generated if the object A2 is assembled with the current object A1. Hence, the assembly instruction system 100 can further prompt the user to pick up the object A2 so as to be assembled with the current object A1. In one embodiment, the assembly tree can be defined by users in advance. In another embodiment, when the processor 24 recognizes the current object (such as the object A6), the processor 24 then learns that the current object A6 can be assembled with the objects A7, A8, A9 which have the same father node by reading data of the assembly tree. In addition, as known from the assembly tree, the object A10 can be generated if the current object A6 is assembled with the objects A7, A8, A9. Hence, the assembly instruction system 100 can further prompt the user to pick up the objects A7, A8 and/or A9 so as to be assembled with the current object A6. It is thus understood that the assembly instruction system 100 can prompt the user to pick up one or more objects so as to perform assembly according to setting of the assembly tree.

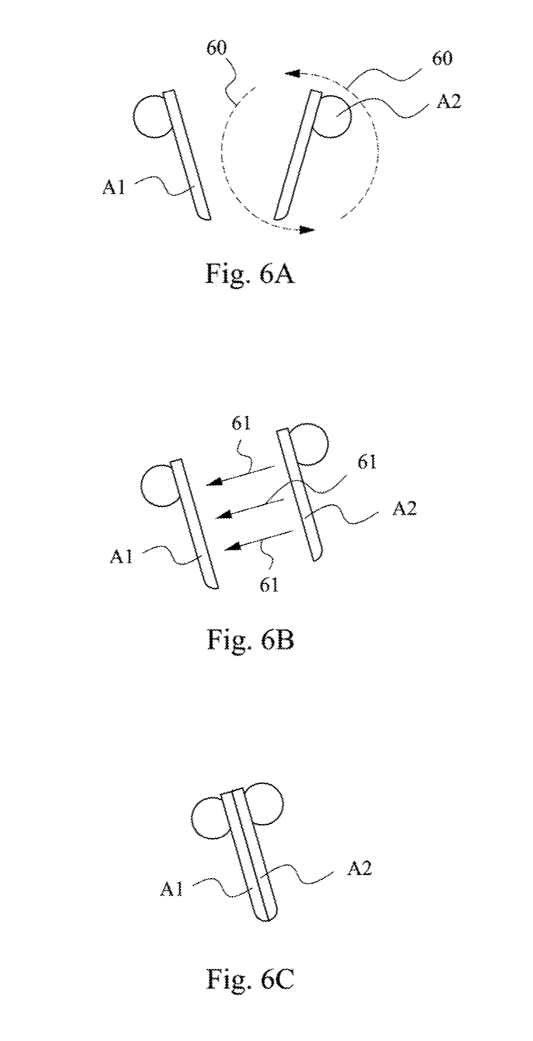

In the present embodiment, when the user knows that the current object A1 can be assembled with the object A2 from the assembly instruction system 100, the user can pick up the object A1 and the object A2 and simultaneously position the objects A1, A2 within a picture range that can be captured by the depth camera 10, so that the depth camera 10 can simultaneously capture the object A1 and the object A2. When the processor 24 utilizes the above method to recognize the objects A1, A2 presented in an image captured by the depth camera 10 and the three-dimensional positions thereof, the processor 24 can generate a virtual arrow (such as a virtual arrow 60 shown in FIG. 6A) according to the three-dimensional positions of the object A1 and/or the object A2. The virtual arrow 60 is used for indicating a moving direction of the object A1 and/or the object A2. In other words, the object A1 and/or the object A2 can be assembled according to the moving direction. In one embodiment, the moving direction comprises a rotation direction or a translation direction. An instruction method of the processor 24 to adjust the virtual arrow 60 correspondingly and a method for displaying the virtual arrow 60 are further described as follows.

In step S240, the display 30 displays an augmented reality image having the at least one virtual arrow added on the first object image or the second object image.

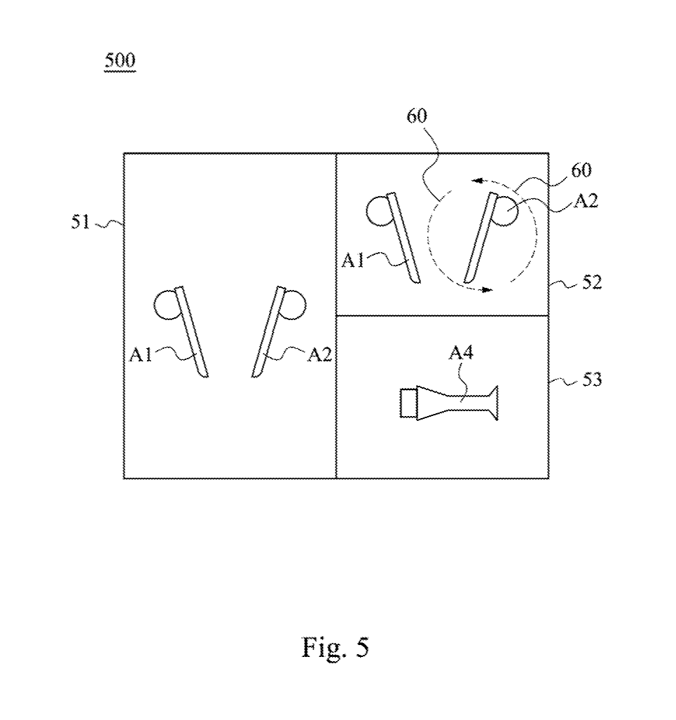

A description is provided with reference to FIG. 5 and FIG. 6A to FIG. 6C. FIG. 5 depicts a schematic diagram of a user interface 500 according to one embodiment of the present disclosure. FIG. 6A to FIG. 6C depict schematic diagrams of augmented reality images 52 in the user interface 500 according to one embodiment of the present disclosure. In FIG. 5, the user interface 500 can be displayed on the display 30, and the user interface 500 can be divided into a practically captured image 51, the augmented reality image 52, and an instructional image for a next object 53. In one embodiment, the practically captured image 51 is a real-time image of the physical object A1 and/or object A2 captured by the depth camera 10. In other words, when the depth camera 10 captures the physical objects A1, A2, the situation captured by the depth camera 10 will be displayed in the practically captured image 51 in real time. In addition, the augmented reality image 52 is used for displaying the virtual arrow (such as the virtual arrow 60 shown in FIG. 6A) generated by the processor 24. Thus, the user can be informed how to rotate, turn over, or translate the object A2 through the augmented reality image 52 so that the object A2 corresponds to the object A1. Additionally, the instructional image for the next object 53 is used for displaying an object that is suggested to be picked up by the user next (such as the object A4).

For example, when the object A1 and the object A2 are both in the practically captured image 51, the user can know that the object A2 should be turned left from the augmented reality image 52 so as to correspond to the object A1. In addition, the processor 24 can look up the assembly tree to know that the user should pick up the object A4 so as to continue the assembly process when the object A1 and the object A2 have been assembled. Hence, the object A4 is displayed in the instructional image for the next object 53 for the reference of the user.

In one embodiment, as shown in FIG. 6A, the virtual arrow 60 used for indicating the rotation direction is an arc arrow. In one embodiment, the arc arrow encircles the object that needs to be rotated or turned over by using a dashed line or a solid line and a pointing direction is added.

In one embodiment, as shown in FIG. 6B, a virtual arrow 61 used for indicating the translation direction is a line arrow. The user can know that the object A1 and the object A2 can be assembled if the object A2 is directly translated towards the lower left from the virtual arrows 61. In one embodiment, the line arrow may be a dashed line or a solid line. In one embodiment, the virtual arrow 60 in FIG. 6A and the virtual arrow 61 in FIG. 6B are of different sizes, shapes, and colors.

In one embodiment, when the object A2 is rotated or turned over to a specific position corresponding to the object A1 according to the rotation direction indicated by the virtual arrow 60 (for example, as shown in FIG. 6A), the virtual arrow 60 is switched to the virtual arrow 61 (as shown in FIG. 6B) to indicate the translation direction.

For example, when the processor 24 determines that the object A1 in the image can be engaged with, joined to, or adhered to the object A2 after being rotated to the right by 20 degrees, the processor 24 first generates the virtual arrow (such as the virtual arrow 60 in FIG. 6A) that is used for indicating the rotation direction, and the virtual arrow 60 encircles the object A2 to inform the user of the direction to which the object A2 should be rotated. After that, when the user has rotated the object A2 to the left by 20 degrees, the processor 24 determines that the object A2 has been positioned at a specific position corresponding to the object A1, the virtual arrow 60 is switched to another virtual arrow (such as the virtual arrow 61 in FIG. 6B) to indicate the translation direction instead.

In one embodiment, when the processor 24 determines that a distance between the object A2 and the object A1 is less than a distance threshold value (such as 5 centimeters), the virtual arrow 60 is switched to the virtual arrow 61 (as shown in FIG. 6B) to instruct that the object A2 moves towards the translation direction represented by the virtual arrow so as to be assembled with the object A1.

Similarly, in one embodiment, the object A1 may also be encircled by the virtual arrow 60 to instruct the direction to which the object A1 should be rotated or turned over. Or, the virtual arrow 61 is used to indicate the direction along which the object A1 should be translated so as to correspond to the three-dimensional position and a three-dimensional orientation of the object A2.

Additionally, in one embodiment, the assembly instruction system 100 may further comprise augmented reality glasses so that the physical object A1 can be seen through the augmented reality glasses and the augmented reality glasses can display the virtual arrow 61. Hence, the user can see the virtual arrow 60 added on the object A1 and the object A2 after wearing the augmented reality glasses.

In this manner, the user can hold various objects (such as the object A1) to be assembled by hand to freely move in the image. The assembly instruction system 100 automatically recognize the identification code and the three-dimensional position and orientation of the object A1 according to the depth and color images captured by the depth camera 10. After the processor 24 utilizes the assembly tree to determine a current assembly step of the object A1, the assembly instruction system 100 will then depict the moving direction and the rotation direction correspondingly and add the moving direction and the rotation direction on the display picture (such as the augmented reality image 52).

By using the above steps, the assembly instruction system 100 can automatically analyze whether an object (such as the object A2) gripped by the user is the object that needs to be currently assembly, prompt the user for the next part that needs to be gripped according to the assembly sequence defined in advance or defined by the user, and determine relative spatial relationships between two objects when the two objects (such as the objects A1, A2) both appear in the image. The assembly instruction system 100 utilizes augmented reality to depict the translation instruction and the rotation instruction in real time, and goes to the next step after the assembly. For example, the assembly instruction system 100 can further prompt the object (such as the object A4) that is suggested to be assembled next. In this manner, the user can complete the assembly process step by step according to dynamic instructions.

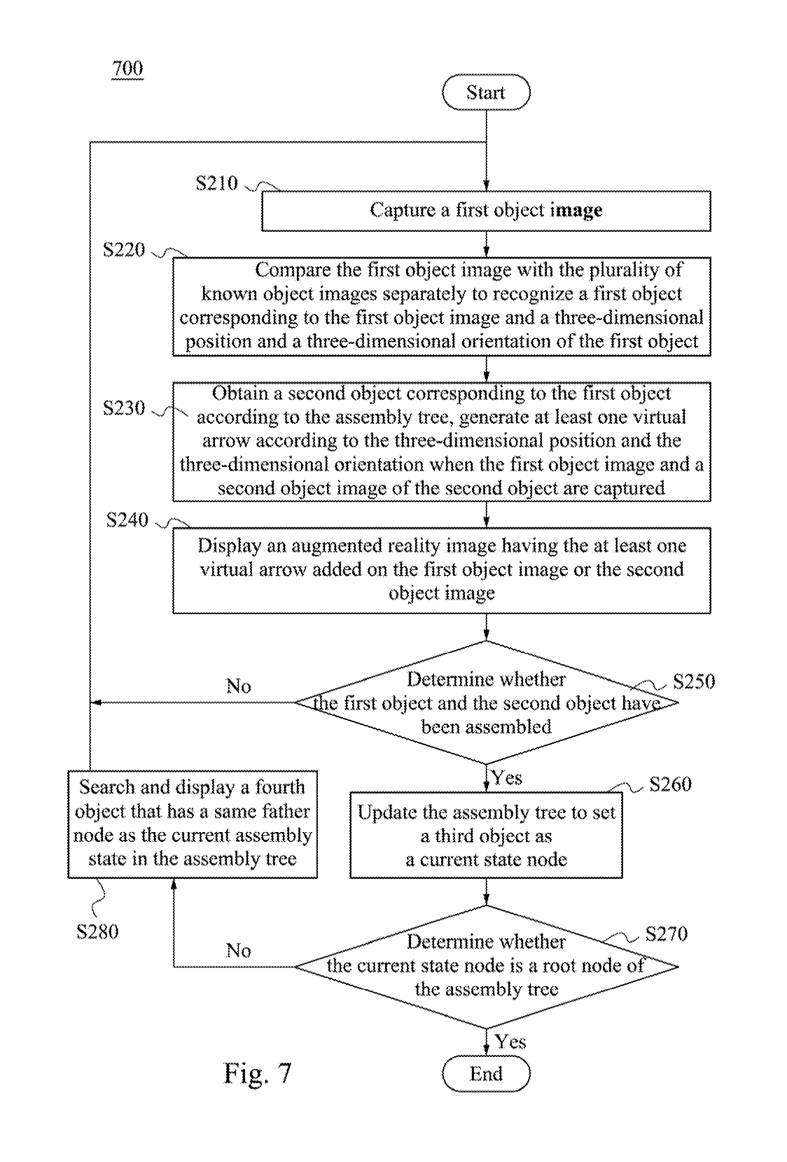

Then, a description is provided with reference to FIG. 7. FIG. 7 depicts a flowchart of an assembly instruction method 700 according to one embodiment of the present disclosure. The difference between FIG. 7 and FIG. 2 is that the assembly instruction method 700 in FIG. 7 further comprises steps S250-S280. Additionally, since steps S210-S240 in FIG. 7 are the same as steps S210-S240 in FIG. 2, a description in this regard is not provided.

In step S250, the processor 24 determines whether the first object and the second object have been assembled. In one embodiment, during the assembly process by the user, the processor 24 will continuously compare various objects present in images captured by the depth camera 10 with the known objects in the database 22. Therefore, when the object A1 and the object A2 are assembled together, the processor 24 can compare images of an object thus assembled (for example, as shown in FIG. 6C) at different view angles with images of the object A3 (for example, as shown in FIG. 4) at different view angles, for example, compare colors or shapes of the two objects in the images at a same view angle to determine whether the object thus assembled has a same appearance as the object A3.

The processor 24 determines that the object A1 and the object A2 have been assembled and goes to step S260 when the processor 24 determines that the object thus assembled is the same as or similar to the object A3. In one embodiment, if the processor 24 determines that a similarity between the object thus assembled and the object A3 is higher than a similarity threshold value (for example, the similarity between the two objects is 99%), the two objects are regarded to have been assembled. The calculation method of similarity may refer to known image similarity algorithms, and a description in this regard is not provided.

On the contrary, if the processor 24 determines that the object thus assembled is not similar to the object A3, for example, if an excessive deviation angle exists between the object thus assembled and the object A3, the two objects are regarded to not have been assembled. The method returns to step S210 to continuously detect images and utilize the method described in steps S220-S240 to continuously update (for example, update the three-dimensional position of the object A1 or the object A2) and adjust the moving direction indicated by the virtual arrow 60 (for example, adjust the virtual arrow 60 according to the updated three-dimensional position of the object A1 or the object A2) so as to continuously inform the user of the assembly method.

In step S260, the processor 24 is configured to update the assembly tree to set a third object as a current state node. In one embodiment, when the processor 24 determines that the object A1 and the object A2 have been successfully assembled, that means the object A3 has been assembled, then the processor 24 sets the object A3 in the assembly tree as the current state node. By setting the current state node, the assembly instruction system 100 is allowed to update a current assembly state and look up which object (such as the object A4) can be further assembled with the current object A3 in the assembly tree.

In step S270, the processor 24 determines whether the current state node is a root node of the assembly tree. In one embodiment, if the current state node (such as the object A3) is not the root node, that means some other object hasn't been assembled (For example, the object A3 should be assembled with the object A4 or the object A5 continuously) and the method goes to step S280. Conversely, if the current state node (such as the object A14) is the root node, that means all of the assembly steps have been completed.

In step S280, the processor 24 searches a fourth object that has a same father node as the current assembly state in the assembly tree. In one embodiment, when a node of the current assembly state is set as the object A3, it can be seen from the assembly tree that the object A3 and the object A4 have a same father node object A7, that means the object A7 is constituted by the object A3 and the object A4. In other words, the object A4 is the object that can be assembled with the object A3 next. Hence, the display 30 displays the object A4 in a next instructional image for the next object 53 to prompt to user to pick up the object A4 so as to perform assembly.

By using the above steps, depth and color information of at least one object can be captured through the depth camera 10, and object templates stored in advance are used to compare the images with the current object to obtain an initial three-dimensional position and orientation of the object. Then, by using the object color and the extended iterative closed point method, the correct position and direction of the current object are found. When more than one object present in the image, the assembly instruction system 100 will determine which two or more objects need to be combined according to the assembly tree, and depict the virtual arrow according to the position and direction of the current object. In addition, the assembly instruction system 100 will also automatically update the state in the assembly tree and display the element that needs to be assembled next until the assembly tree proceeds to the root node where the assembly is completed.

Based on the above description and the detailed description of various embodiments, the assembly instruction system and assembly instruction method according to the present disclosure can compare the current object with the known objects to find out the next object that can be assembled by using the assembly tree, and dynamically depict the virtual arrow according to the three-dimensional position(s) and orientation(s) of the object(s) so as to guide the user to move the object to the correct position. In this manner, the user can conveniently complete the assembly step by step according to the dynamic instructions of the virtual arrow.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims and their equivalents.

What is claimed is:

1. An assembly instruction system comprising:
at least one depth camera configured to capture a first objet image;
a database configured to store a plurality of known object images and an assembly tree;
a processor configured to compare the first object image with the known object images separately to recognize a first object corresponding to the first object image and a three-dimensional position and a three-dimensional orientation of the first object, and obtain a second object corresponding to the first object according to the assembly tree, the processor generating at least one virtual arrow according to the three-dimensional position and the three-dimensional orientation when the at least one depth camera simultaneously captures the first object image and a second object image of the second object; and
a display configured to display an augmented reality image having the at least one virtual arrow added on the first object image or the second object image;
wherein the virtual arrow is used for indicating a moving direction for assembling the first object and the second object.

2. The assembly instruction system of claim 1, wherein the assembly tree is used for defining an assembly relationship between the first object and the second object and an assembly sequence of the first object and the second object, the second object and the first object have a same father node.

3. The assembly instruction system of claim 1, wherein the moving direction indicated by the virtual arrow comprises a rotation direction or a translation direction, the virtual arrow used for indicating the rotation direction is an are arrow, the virtual arrow used for indicating the translation direction is a line arrow.

4. The assembly instruction system of claim 3, wherein after the first object is rotated or turned over to a specific position corresponding to the second object according to the rotation direction indicated by the virtual arrow, the virtual arrow indicates the translation direction instead.

5. The assembly instruction system of claim 1, wherein the processor compares the first object image with a color distribution, a silhouette of a depth image, or a gradient of a depth image of the known object images to recognize the first object corresponding to the first object image and an identification code of the first object.

6. The assembly instruction system of claim 1, wherein the processor recognizes the three-dimensional position and the three-dimensional orientation of the first object based on an extended iterative closed point method.

7. The assembly instruction system of claim 1, wherein the processor is further configured to determine whether the first object has been assembled with the second object;
the processor updates the assembly tree to set a third object as a current state node if the processor determines that the first object has been assembled with the second object, wherein the third object is formed by assembling the first object and the second object;
the processor continuously updates and adjusts the moving direction indicated by the at least one virtual arrow if the processor determines that the first object has not been assembled with the second object.

8. The assembly instruction system of claim 7, wherein the processor is further configured to determine whether the current state node is a root node of the assembly tree after the processor determines that the first object has been assembled with the second object;
the processor is further configured to look for a fourth object having a same father node as the current state node in the assembly tree and the display is configured to display the fourth object if the processor determines that the current state node is not the root node of the assembly tree;
wherein the fourth object is used for being assembled with the third object.

9. The assembly instruction system of claim 1, further comprising:
augmented reality glasses used for displaying the at least one virtual arrow added on the first object and the second object.

10. An assembly instruction method comprising:
capturing a first objet image;
storing a plurality of known object images and an assembly tree;
comparing the first object image with the known object images separately to recognize a first object corresponding to the first object image and a three-dimensional position and a three-dimensional orientation of the first object, and obtaining a second object corresponding to the first object according to the assembly tree, generating at least one virtual arrow according to the three-dimensional position and the three-dimensional orientation when the first object image and a second object image of the second object are captured simultaneously; and
displaying an augmented reality image having the at least one virtual arrow added on the first object image or the second object image;
wherein the virtual arrow is used for indicating a moving direction for assembling the first object and the second object.

11. The assembly instruction method of claim 10, wherein the assembly tree is used for defining an assembly relationship between the first object and the second object and an assembly sequence of the first object and the second object, the second object and the first object have a same father node.

12. The assembly instruction method of claim 10, wherein the moving direction indicated by the virtual arrow comprises a rotation direction or a translation direction, the virtual arrow used for indicating the rotation direction is an arc arrow, the virtual arrow used for indicating the translation direction is a line arrow.

13. The assembly instruction method of claim 12, wherein after the first object is rotated or turned over to a specific position corresponding to the second object according to the rotation direction indicated by the virtual arrow, the virtual arrow indicates the translation direction instead.

14. The assembly instruction method of claim 10, further comprising:
comparing the first object image with a color distribution, a silhouette of a depth image, or a gradient of a depth image of the known object images to recognize the first object corresponding to the first object image and an identification code of the first object.

15. The assembly instruction method of claim 10, further comprising:
recognizing the three-dimensional position and the three-dimensional orientation of the first object based on an extended iterative closed point method.

16. The assembly instruction method of claim 10, further comprising:
determining whether the first object has been assembled with the second object by a processor;
updating the assembly tree to set a third object as a current state node by the processor if the processor determines that the first object has been assembled with the second object, wherein the third object is formed by assembling the first object and the second object;
continuously updating and adjusting the moving direction indicated by the at least one virtual arrow by the processor if the processor determines that the first object has not been assembled with the second object.

17. The assembly instruction method of claim 16, wherein after the processor determines that the first object has been assembled with the second object, the assembly instruction method further comprises:
determining whether the current state node is a root node of the assembly tree;
the processor being further configured to look for a fourth object having a same father node as the current state node in the assembly tree and the displaying the fourth object by a display if the processor determines that the current state node is not the root node of the assembly tree;
wherein the fourth object is used for being assembled with the third object.

18. The assembly instruction method of claim 10, further comprising:
displaying the at least one virtual arrow added on the first object and the second object by augmented reality glasses.
